(19) United States
(12) Patent Application Publication
(10) Pub. No.: US 2007/0031624 A1
(43) Pub. Date: Feb. 8, 2007

(54) Lined water conduit

(76) Inventor: Edward S. Brosius, Saline, MI (US)

Correspondence Address: BAKER & DANIELS LLP, 300 NORTH MERIDIAN STREET, SUITE 2700, INDIANAPOLIS, IN, 46204, US

(21) Appl. No.: 11/197,826

(22) Filed: Aug. 5, 2005

(51) Int. Cl. F16L 11/04

(52) U.S. Cl. 428/36.91

(57) ABSTRACT

A method of lining the interior passageway of a water conduit and the article produced thereby is disclosed.

### BACKGROUND AND SUMMARY OF THE INVENTION

The present invention relates generally to water conduits. More particularly, the invention relates to a method of producing a lined water conduit which is resistant to the leaching of metals from the conduit into water passing therethrough, and the water conduit formed thereby.

Potable water systems may include numerous components such as pipes, faucets, valves, and couplings, which are configured to transport and control the flow of water. Such components have traditionally been made of copper based alloys with lead dispersed therein. The lead allows for easier machining into a final product which has a predetermined shape with acceptable strength and watertight properties.

For example, faucet assemblies traditionally include metallic delivery spouts which may be subject to corrosion and leaching of metals from the inner spout surface contacting the water flowing therethrough. This is particularly true with cast spouts having rough inner surfaces and/or residual sand from the casting process.

Metals, particularly lead used to improve the machinability of copper alloy materials, may be harmful to humans when consumed as a result of leaching into potable water. To reduce the risk of exposure to such metals, governmental agencies now typically regulate the metal content in potable water by restricting the amount of metal that can be leached from plumbing fixtures. Many governmental entities have adopted the standard known as ANSI (American National Standard Institute)/NSF (National Sanitation Foundation International) 61, which relates to the presence of certain contaminants in drinking water systems. More particularly ANSI/NSF 61 testing is required to evaluate and certify that the potential doses of metal ions are not above established limits. In addition to metal leaching, conventional spout tubes are also often prone to corrosion failure, such as layer dezincification, crevice corrosion, deposit corrosion, and pin hole corrosion. In severe cases, perforation can result in failure of the spout.

According to an illustrative embodiment of the present disclosure, a water conduit includes a support tube formed of a metallic material. The support tube includes an outer surface and an inner surface extending between an inlet and an opposing outlet. A thermoplastic liner is molded within the support tube. The thermoplastic liner includes an outer surface substantially contacting the inner surface of the support tube from the inlet to the outlet.

According to another illustrative embodiment of the present disclosure, a delivery spout for a water faucet assembly includes an outer cover formed of a metallic material. A liner is received within the outer cover, and is formed of a cross-linked polyethylene.

According to yet another illustrative embodiment of the present disclosure, a method is provided for forming a water conduit. The method includes the steps of providing a support tube including a first end, a second end, and an inner surface defining a passageway extending between the first end and the second end. The method further includes the steps of providing a thermoplastic material, and inserting the thermoplastic material within the passageway of the support tube. The method also includes the steps of heating the thermoplastic material, molding the thermoplastic material within the support tube, and cooling the thermoplastic material within the support tube.

According to yet another illustrative embodiment of the present disclosure, a method of forming a delivery spout for a water faucet assembly is provided. The method includes the steps of providing a metallic support tube including a passageway, and providing a polyethylene material. The method further includes the steps of inserting the polyethylene material within the passageway of the support tube, and heating the polyethylene material. The method also includes the steps of molding the polyethylene material within the support tube, and cross-linking the polyethylene material within the support tube.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 is a perspective view of a water faucet assembly including an illustrative embodiment delivery spout of the present disclosure;

FIG. 2 is a partial cross-sectional view of an illustrative embodiment delivery spout, taken along line 2-2 of FIG. 1;

FIG. 3 is a detailed view of the delivery spout of FIG. 2;

FIG. 4 is a cross-sectional view of a further illustrative embodiment delivery spout of the present disclosure;

FIG. 5A is a schematic view of an insertion step of an illustrative embodiment method of the present disclosure;

FIG. 5B is a schematic view of a sealing step of an illustrative embodiment method of the present disclosure;

FIG. 5C is a schematic view of a molding step of an illustrative embodiment method of the present disclosure;

FIG. 5D is a schematic view of a cooling step of an illustrative embodiment method of the present disclosure; and

FIG. 6 is a flow chart showing an illustrative embodiment method of the present disclosure.

### DETAILED DESCRIPTION OF THE DRAWINGS

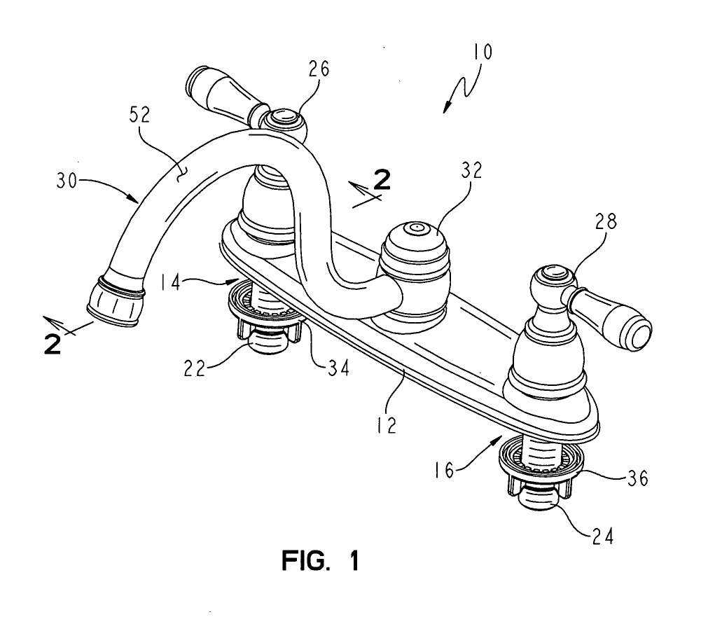

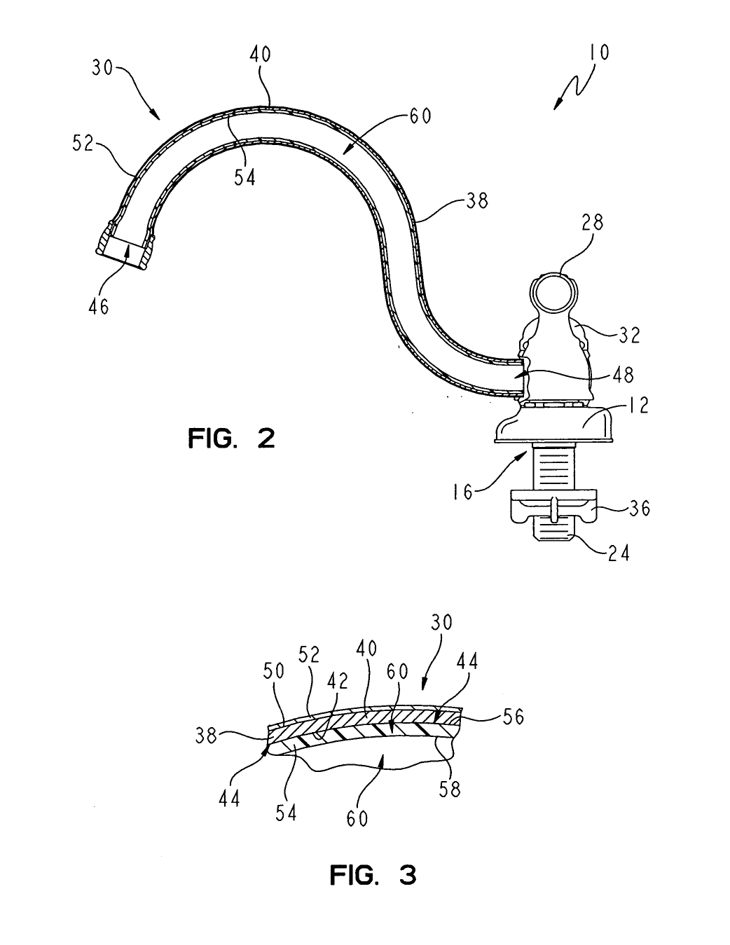

Referring initially to FIGS. 1 and 2, an illustrative embodiment water faucet assembly 10 includes a base or escutcheon 12 configured to be coupled to a mounting deck adjacent a sink (not shown). A hot water valve 14 and a cold water valve 16 are fluidly coupled to hot and cold water supplies (not shown) through inlet tubes 22 and 24, respectively. A hot water handle or knob 26 is coupled to the hot water valve 14, while a cold water handle or knob 28 is coupled to the cold water valve 16. A delivery spout 30 is fluidly coupled to the valves 14 and 16 through a center hub 32. Rotation of the valves 14 and 16 controls the flow of hot and cold water to the delivery spout 30.

Mounting members 34 and 36 are threadably received on tubes 22 and 24 of the valves 14 and 16, and are configured to facilitate mounting of the escutcheon 12 to the mounting deck.

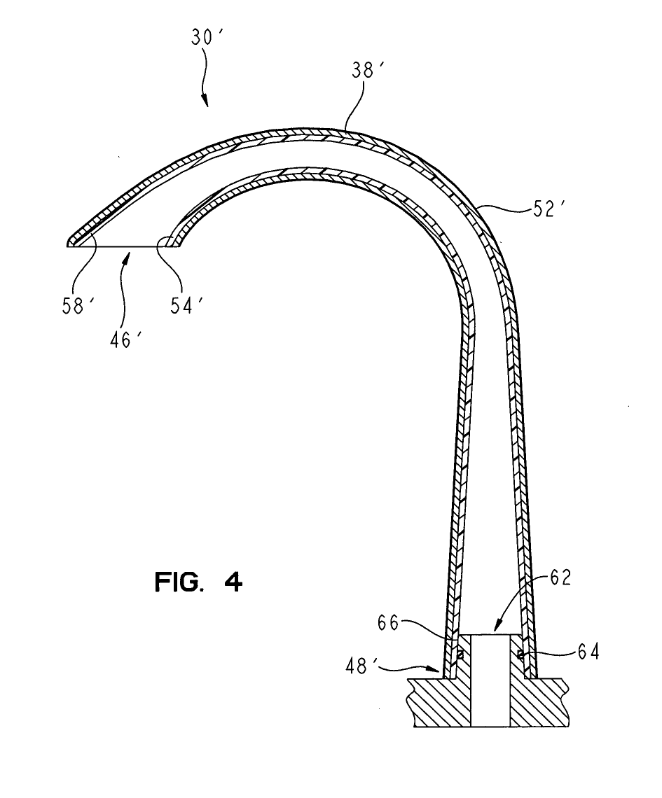

With reference to FIGS. 2 and 3, the illustrative embodiment delivery spout 30 of the present disclosure includes a support tube 38 including a wall 40 defining a substantially circular cross-section. The wall 40 of the support tube 38 is illustratively formed of a material, such as brass, and includes an inner surface 42 defining an internal passageway 44 extending between a first end 46 and a second end 48. The wall 40 of the support tube 38 also includes an outer surface 50.

A plating layer 52 may be applied to, and supported by, the outer surface 50 of the tube 38. The plating layer 52 may comprise any one of many known metallic compositions, depending upon the metal composition of the tube 38. Illustratively, the plating layer 52 may comprise a copper-nickel-chromium or nickel-chrome finish.

A liner 54 is received within the passageway 44 of the tube 38. The liner 54 includes an outer surface 56 which substantially contacts the inner surface 42 of the tube 38 from the first end 46 to the second end 48. The liner 54 further includes an inner surface 58 which defines a water passageway 60.

Illustratively, the liner 54 comprises a thermoplastic material and, more particularly, a cross-linked polyethylene, or PEX. Cross-linked polyethylene is a known material in which polyethylene macromolecules are formed to create bridges between polyethylene (PE) molecules (i.e., cross-linked). The resulting PEX molecule is more durable under temperature extremes, chemical attack, and resists creep deformation. As such, PEX is an excellent material for hot water applications.

While FIGS. 1-3 show an illustrative embodiment delivery spout 30, it should be appreciated that the present disclosure may find equal applicability with a wide variety of different delivery spout styles and designs. Moreover, the PEX liner 54 may be used with other types of water conduits, such as decorative risers.

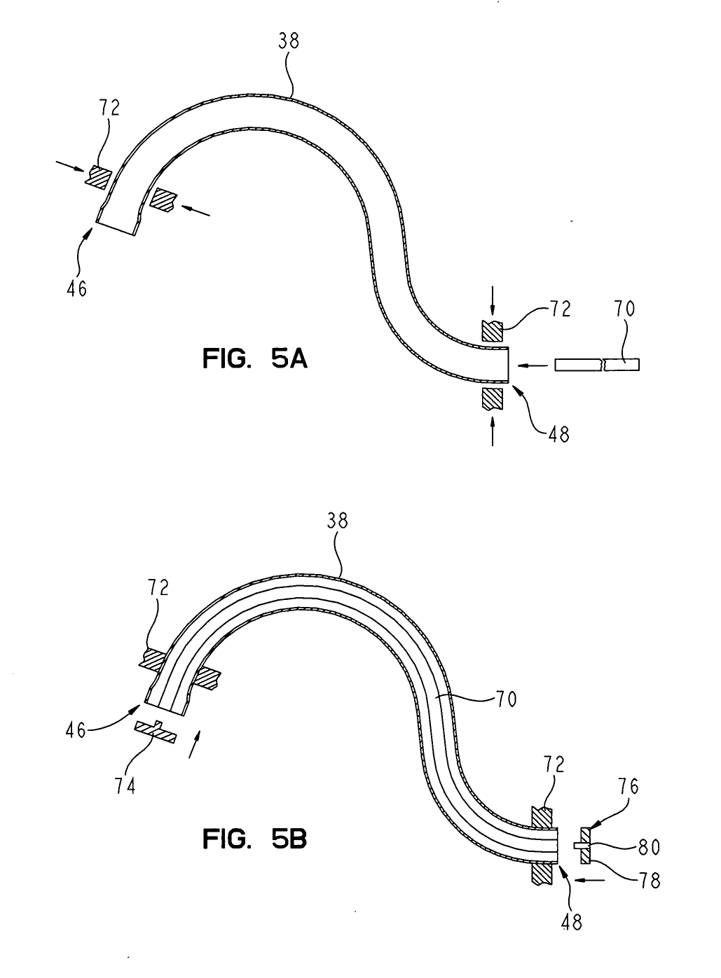

A further illustrative embodiment delivery spout 30′ is shown in FIG. 4 as being supported by a rotatable coupling 62. Little or no modification of the coupling 62 is required since the PEX liner 54′ may be sealed proximate ends 46′ and 48′ by conventional elastomeric seals engaging the inner surface 58′. For example, conventional rotatable coupling 62 includes an o-ring 64 on its outer surface 66 which seals the inner surface 58′ of the PEX liner 54′. Such an arrangement helps prevent the possibility of crevice corrosion. Since the water only contacts the inner surface 58′ of the liner 54′, there is no potential metal corrosion or leachate from the spout tube 38′.

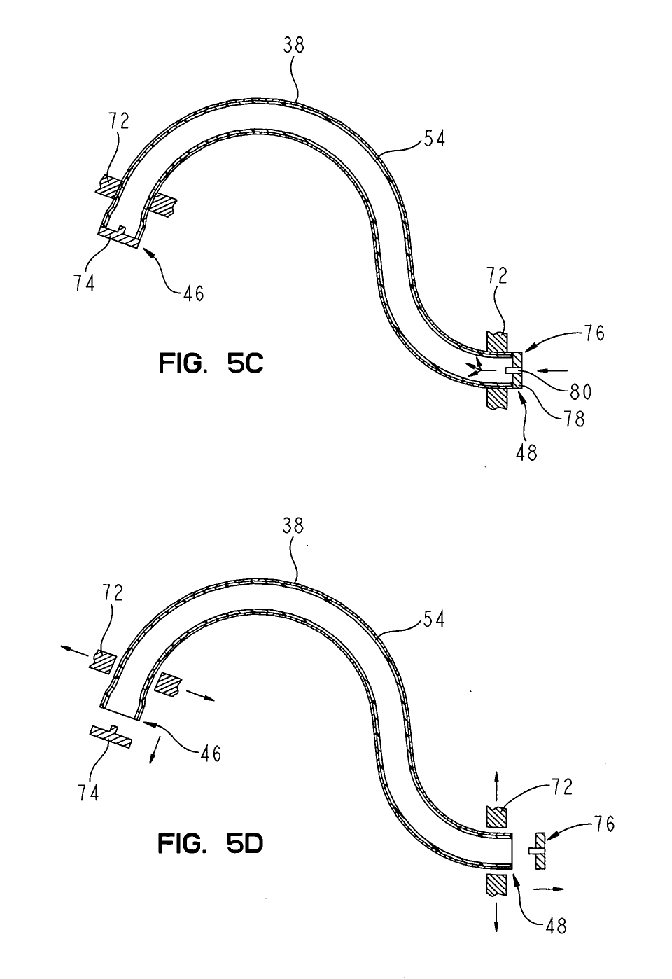

Referring now to FIGS. 5A-5D, an illustrative embodiment method of forming the delivery spout 30 is shown. Illustratively, the liner 54 is formed within the support tube 38 through a molding process. In one illustrative embodiment, the process is a blow molding process in which air pressure is used to inflate the PEX liner 54 within the tube 38. In such a process, the support tube 38 defines a mold.

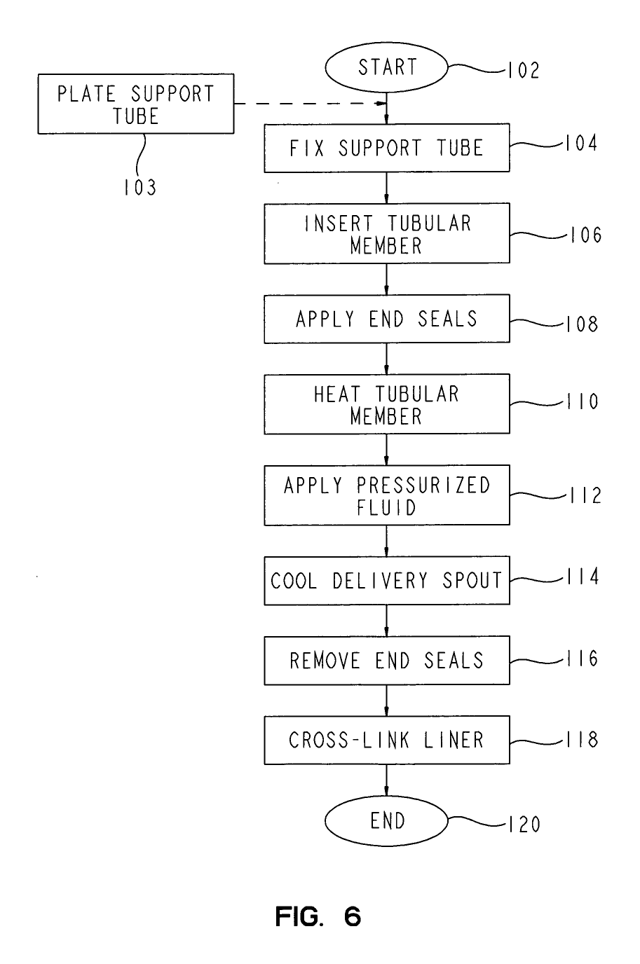

With reference to FIGS. 5A and 6, the process begins at block 102 by providing the support tube 38. At block 103, the support tube 38 may be provided with the plating layer 52, of the type detailed herein, through a conventional plating process. Next, at block 104, the support tube 38 is secured within a conventional fixture 72. During insertion step 106, a tubular member, or parison, of PEX 70 is inserted into the second end 48 of the support tube 38. Since the tubular member 70 is flexible, as it is inserted it follows the contour of the support tube 38. Next, during sealing step 108 as shown in FIG. 5B, the first end 46 of the tube 38 is sealed with a plug or cap 74 and the second end 48 of the tube 38 is sealed with a blow pin assembly 76. The blow pin assembly 76 illustratively includes a support member 78 and a blow pin or tube 80. At block 110, the tubular member 70 is heated. Heating may be accomplished by a variety of methods, for example, by applying hot air to the tubular member 70 and/or support tube 38, placing a heating coil in contact with the support tube 38, or by placing the tubular member 70 and the support tube 38 within an oven.

Next, during molding step 112 as shown in FIG. 5C, the tubular member 70 is inflated by introducing pressurized air through the blow pin 80. The PEX of the tubular member 70 expands and substantially conforms to the shape of the tube 38. More particularly, the tubular member 70 moves radially outwardly into substantial contact with the inner surface 42 of the support tube 38. Next, at block 114, the resulting delivery spout 30 is cooled, and at block 116 the plug 76 and blow pin assembly 76 are removed. The delivery spout 30 may be subsequently removed from the fixture 72. The PEX of the liner 54 is then illustratively cross-linked by a curing process at block 118.

The curing or cross-linking process may use any one of several different technologies. Illustratively, the tubular member 70 is formed of a silane-grafted polyethylene which is then “moisture-cured” by exposure to heat and water, also known as sauna curing. It should be appreciated that either a radiation PEX or a peroxide PEX may also be used. A radiation PEX is cross-linked by bombarding it with electromagnetic (gamma) or high energy electron (beta) radiation. Peroxide PEX is formed of a polyethylene having incorporated therein peroxide materials. Upon heating the peroxide polyethylene above the decomposition temperature of the peroxides, “free” radicals are produced to initiate the cross-linking process.

While the illustrative embodiment utilizes a blow molding process to form the lined delivery spout 30, it should be appreciated that other molding methods may also be used, such as rotational molding. Rotational molding uses gravity inside a rotating mold to achieve a hollow form. In such a process, a predetermined amount of polyethylene is loaded within the support tube 38. The tube 38 is then heated and simultaneously rotated on two perpendicular axes, so that the powder impinges on substantially all internal surfaces of the tube 38, gradually forming a fused layer of substantially uniform thickness. While still rotating, the tube 38 is then cooled so that the plastic liner solidifies. The cross-linking process may then be performed in the same manner as detailed herein.

Although the invention has been described in detail with reference to certain preferred embodiments, variations and modifications exist within the spirit and scope of the invention as described and defined in the following claims.

1. A water conduit faucet assembly comprising:
a base;
a delivery spout supported by the base and formed of a metallic material, the delivery spout including an outer surface and an inner surface extending between an inlet and an opposing outlet; and
a thermoplastic liner molded within the delivery spout, the thermoplastic liner having an outer surface substantially contacting the inner surface of the delivery spout from the inlet to the outlet.

2. The water faucet assembly of claim 1, wherein the thermoplastic liner is formed of a polyethylene.

3. The water faucet assembly of claim 2, wherein the thermoplastic liner is formed of a cross-linked polyethylene.

4. The water faucet assembly of claim 1, further comprising a plating layer received on the outer surface of the support tube.

5. (canceled)

6. A delivery spout for a water faucet assembly, the delivery spout comprising:
an outer cover formed of a metallic material; and
a liner received within the outer cover, the liner being formed of a cross-linked polyethylene.

7. The delivery spout of claim 6, wherein the liner is molded within the outer cover.

8. The delivery spout of claim 7, wherein the liner is blow molded within the outer cover.

9. The delivery spout of claim 6, wherein the linter has an outer surface which contacts the inner surface of the outer cover from the inlet to the outlet.

10. The delivery spout of claim 6, further comprising a plating layer received on the outer surface of the outer cover.

11. A method of forming a water conduit, the method comprising the steps of:
providing a support tube including a first end, a second end, and an inner surface defining a passageway extending between the first end and the second end;
providing a thermoplastic material;
inserting the thermoplastic material within the passageway of the support tube;
heating the thermoplastic material;
placing a tubular member of the thermoplastic material within the passageway of the support tube, the tubular member having a first end and a second end;
sealing the first end of the tubular member with a plug;
sealing the second end of the tubular member with a blow pin assembly;
applying pressurized fluid to the second end of the tubular member; and
cooling the thermoplastic material within the support tube.

12. The method of claim 11, wherein the thermoplastic material comprises a polyethylene, and the method further comprises the step of cross-linking the polyethylene.

13. The method of claim 12, wherein the cross-linking step includes providing a silane-grafted polyethylene and exposing the silane-grafted polyethylene to moisture and heat.

14. (canceled)

15. The method of claim 11, further comprising the step of metal plating the outer surface of the support tube.

16. The method of claim 11, wherein the support tube comprises a delivery spout of a water faucet assembly.

17. A method of forming a delivery spout for a water faucet assembly, the method comprising the steps of:
providing a metallic support tube including a passageway;
providing a polyethylene material;
inserting the polyethylene material within the passageway of the support tube;
heating the polyethylene material;
molding the polyethylene material within the support tube; and
cross-linking the polyethylene material within the support tube.

18. The method of claim 17, wherein the cross-linking steps includes providing a silane-grafted polyethylene and exposing the silane-grated polyethylene to moisture and heat.

19. The method of claim 17, wherein the molding step includes placing a tubular member of the polyethylene material within the passageway of the support tube, the tubular member having a first end and a second end, sealing the first end of the tubular member, and applying pressurized fluid to the second end of the tubular member.

20. The method of claim 17, further comprising the step of metal plating the outer surface of the support tube.

21. The water faucet assembly of claim 3, wherein the thermoplastic liner is cross-linked within the delivery spout.

22. The water faucet assembly of claim 1, further comprising a rotatable coupling supporting the delivery spout.
